(19) United States
(12) Patent Application Publication
(10) Pub. No.: US 2026/0040176 A1
(43) Pub. Date: Feb. 5, 2026

(54) SYSTEMS AND METHODS FOR OPTIMIZING A VOICE-OVER-WIFI CALL FOR A VOICE-OVER-NEW RADIO DEVICE

(71) Applicant: Verizon Patent and Licensing Inc., Basking Ridge, NJ (US)

(72) Inventors: Samirkumar PATEL, Middlesex, NJ (US); Jeremy NACER, Boca Raton, FL (US); Douglas C. OESTERLIN, Fort Worth, TX (US)

(73) Assignee: Verizon Patent and Licensing Inc., Basking Ridge, NJ (US)

(21) Appl. No.: 18/790,593

(22) Filed: Jul. 31, 2024

(51) Int. Cl. H04W 36/14; H04W 36/00; H04W 36/08; H04W 36/24; H04W 84/12

(52) U.S. Cl. CPC H04W 36/144; H04W 36/08; H04W 36/24; H04W 36/00224; H04W 84/12

(57) ABSTRACT

A device may initiate a voice-over-Wi-Fi (VoWiFi) call with an access point, and may receive first cell information associated with a first base station providing New Radio (NR) access and information indicating whether voice-over-NR (VoNR) is supported by the first base station. The device may receive second cell information associated with a second base station providing Long Term Evolution (LTE) access, and may temporarily store information associated with the VoWiFi call, the first cell information, the second cell information, and the information indicating whether VoNR is supported by the first base station. The device may selectively hand over the VoWiFi call to the second base station based on the information indicating that VoNR is not supported by the first base station, or hand over the VoWiFi call to the first base station based on the information indicating that VoNR is supported by the first base station.

### BACKGROUND

In the rapidly evolving landscape of wireless telecommunications, particularly with the advent of fifth-generation 5G standalone (SA) networks, maintaining the quality of voice communication remains a critical requirement. Currently, 5G SA networks (e.g., gNodeBs or gNBs) only support evolved packet system (EPS) fallback (FB) for a voice call from a user equipment (UE).

### BRIEF DESCRIPTION OF THE DRAWINGS

FIGS. 1A-1F are diagrams of an example associated with optimizing a voice-over-Wi-Fi (VoWiFi) call for a voice-over-New Radio (VoNR) device.

FIG. 2 is a diagram of an example environment in which systems and/or methods described herein may be implemented.

FIG. 3 is a diagram of example components of one or more devices of FIG. 2.

FIG. 4 is a flowchart of an example process for optimizing a VoWiFi call for a VoNR device.

### DETAILED DESCRIPTION OF EXAMPLE EMBODIMENTS

The following detailed description of example implementations refers to the accompanying drawings. The same reference numbers in different drawings may identify the same or similar elements.

During transition from Long Term Evolution (LTE) to 5G SA, many networks initially do not support voice-over-New Radio (VoNR), which necessitates the use of evolved packet system (EPS) fallback (FB) to LTE for voice calls. This imposes notable challenges, especially when voice calls are initiated or ongoing over voice-over-Wi-Fi (VoWiFi), and there is a need to handover the call to a cellular network. When an EPS FB supported device (e.g., a UE) is in a VoWiFi call or is connected to Wi-Fi, the UE deprioritizes or disables the 5G SA to prevent handover from the Wi-Fi to the 5G SA. This prevents multiple handovers from Wi-Fi, to 5G SA (e.g., gNodeBs), and to fourth-generation (4G) devices (e.g., eNodeBs or eNBs providing LTE access) when the UE is on a VoWiFi call. Such multiple handovers cause audio gaps and call drops. The 5G SA de-prioritization and disable while connected to Wi-Fi or during an on ongoing VoWiFi call is utilized because there is currently no support for VoNR on UEs and 5G access devices (e.g., gNodeBs). In the future, when UEs and 5G access devices start supporting VoNR, disabling SA or deprioritizing the SA will not be a permanent option for the UEs and the 5G access devices. However, some 5G access devices may not enable VoNR and the UE will still utilize the EPS FB for a voice call. Thus, a VoNR supported UE will experience audio gaps and call drops when a call is handed over from Wi-Fi to the 5G access device (e.g., with no VoNR support) and then to the EPS FB. Currently, there is no mechanism that enables the VoNR supported UE to determine whether an access network supports VONR before handing over a voice call from Wi-Fi to the access network.

Thus, current techniques for handing over a voice call to an access network consume computing resources (e.g., processing resources, memory resources, communication resources, and/or the like), networking resources, and/or other resources associated with performing multiple handovers for a VoWiFi call to a 5G access device and then to a 4G access device (e.g., the EPS FB), causing a poor user experience for a user of a UE due to the multiple handovers for a VoWiFi call, unnecessarily utilizing resources of a 5G access device that does not support VoNR, and/or the like.

Some implementations described herein provide a UE that optimizes a VoWiFi call for a VoNR device. For example, the UE may initiate a VoWiFi call with an access point, and may receive first cell information associated with a first base station providing NR access and information indicating whether VoNR is supported by the first base station. The UE may receive second cell information associated with a second base station providing LTE access, and may temporarily store information associated with the VoWiFi call, the first cell information, the second cell information, and the information indicating whether VoNR is supported by the first base station. The UE may selectively hand over the VoWiFi call to the second base station based on the information indicating that VoNR is not supported by the first base station, or hand over the VoWiFi call to the first base station based on the information indicating that VoNR is supported by the first base station.

In this way, the UE optimizes a VoWiFi call for a VoNR device. For example, the UE may optimize voice call transitions between VoWiFi and 5G SA networks. The UE may initiate a VoWiFi call and may receive cell information from both a first base station with NR access and a second base station providing LTE access, including data indicating whether VoNR is supported by the first base station. The UE may temporarily store relevant information associated with the call and the cell information, and may selectively hand over the call to the appropriate base station based on the VoNR support status. Thus, the UE may conserve computing resources, networking resources, and/or other resources that would have otherwise been consumed by performing multiple handovers for a VoWiFi call to a 5G access device and then to a 4G access device (e.g., the EPS FB), causing a poor user experience for a user of the UE due to the multiple handovers for a VoWiFi call, unnecessarily utilizing resources of a 5G access device that does not support VONR, and/or the like.

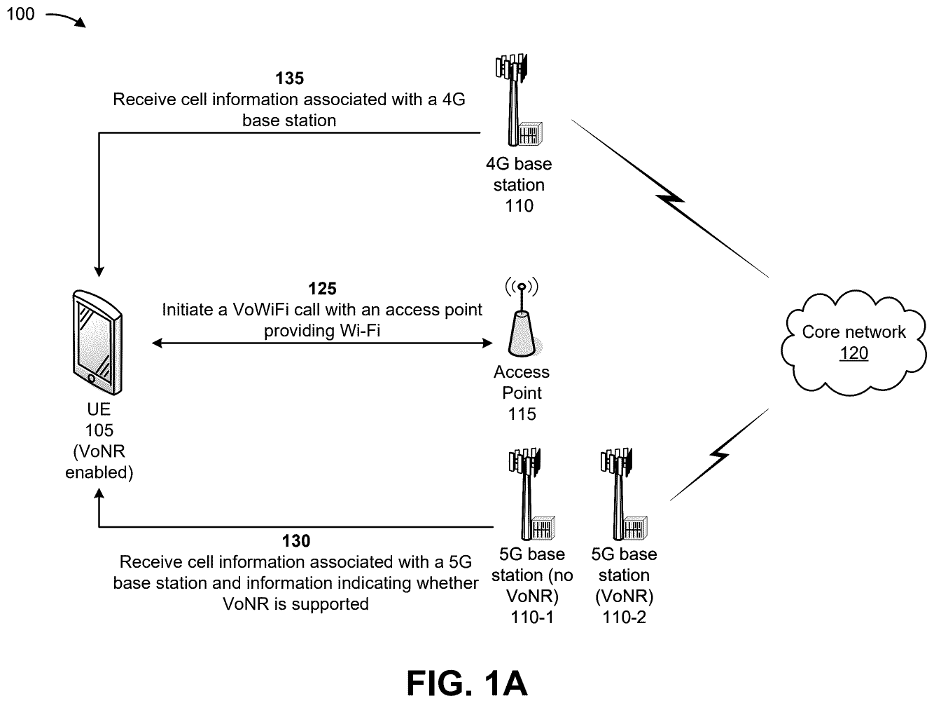

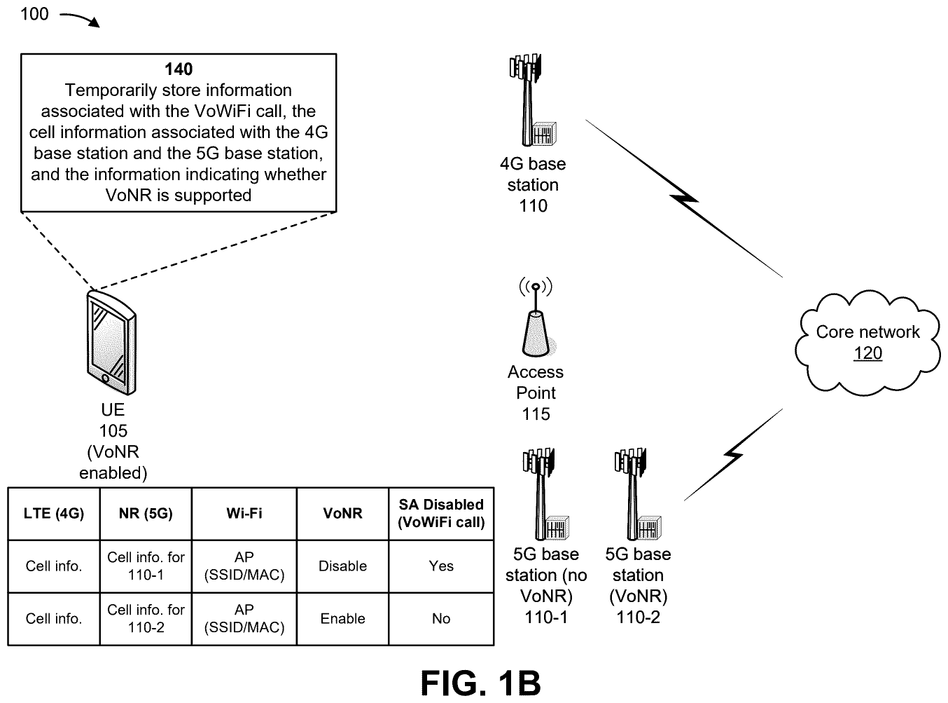

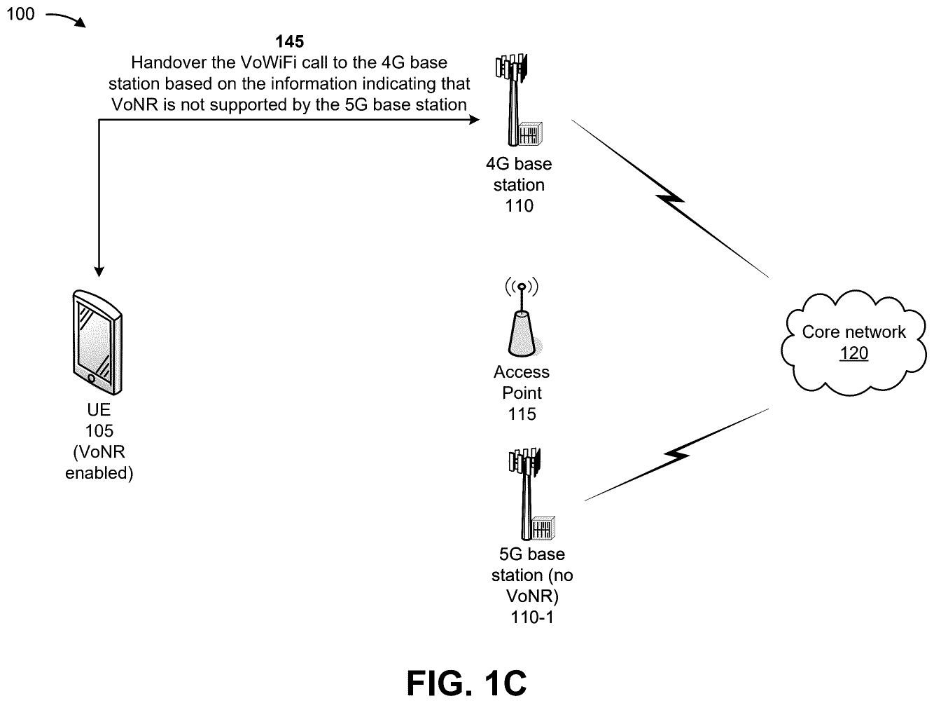

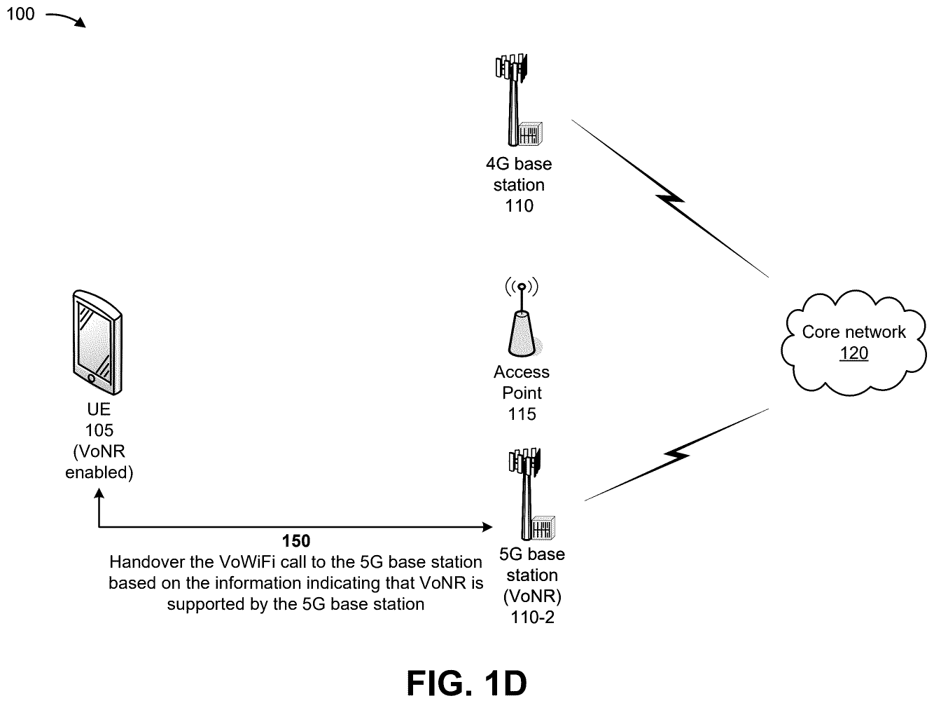

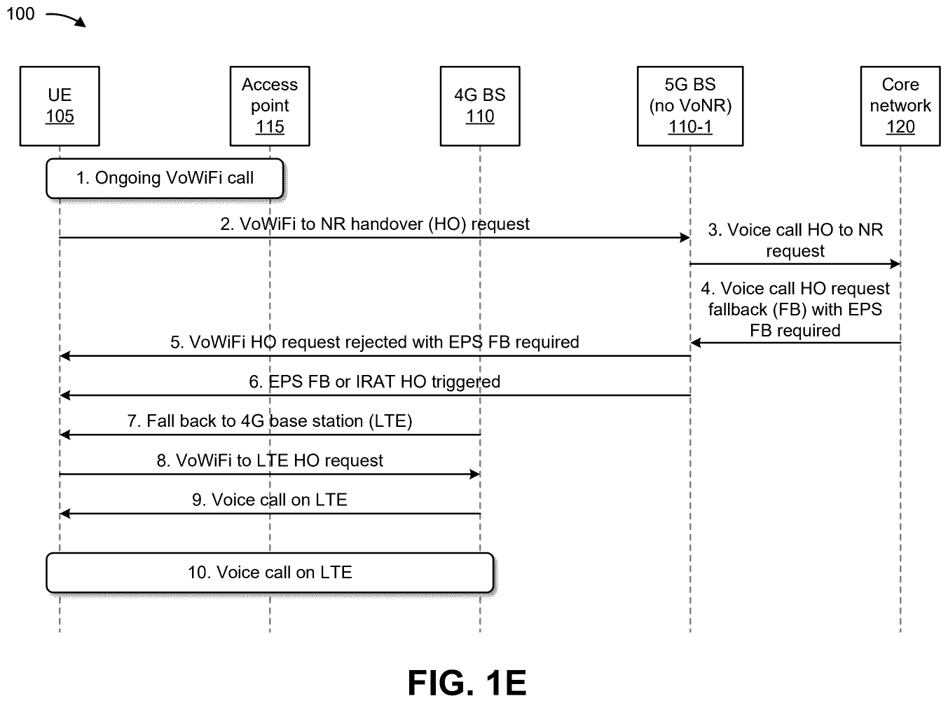

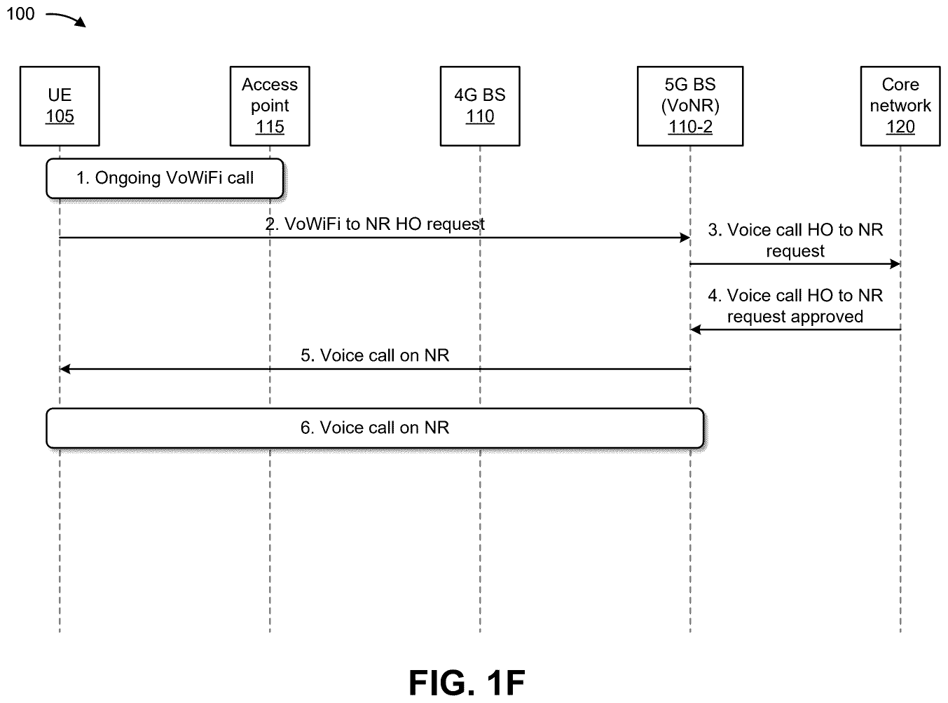

FIGS. 1A-1F are diagrams of an example 100 associated with optimizing a VoWiFi call for a VoNR device. As shown in FIGS. 1A-1F, example 100 includes a UE 105 (e.g., a VoNR enabled device) associated with a 4G base station 110, a first 5G base station 110-1 (e.g., that does not support VONR and supports LTE), a second 5G base station 110-2 (e.g., that supports VONR and LTE), an access point 115, and a core network 120. Further details of the UE 105, the 4G base station 110, the first 5G base station 110-1, the second 5G base station 110-2, the access point 115, and the core network 120 are provided elsewhere herein.

As shown in FIG. 1A, and by reference number 125, the UE 105 may initiate a VoWiFi call with the access point 115 providing Wi-Fi. For example, the UE 105 may establish a voice communication link utilizing Wi-Fi connectivity through the access point 115 for placing or receiving the VoWiFi call. In some implementations, initiating the VoWiFi call may include commencing a voice call using a connection to the access point 115. The UE 105 may assess the availability and strength of the Wi-Fi connection prior to initiating the VoWiFi call, considering factors such as signal quality and load on the access point 115 to ensure an optimal calling experience. Additionally, or alternatively, the UE 105 may establish a VoWiFi call as a default preference over cellular calls when connected to a known Wi-Fi network provided by the access point 115, thereby optimizing for cost and quality whenever the UE 105 identifies a trusted and robust Wi-Fi connection.

As further shown in FIG. 1A, and by reference number 130, the UE 105 may receive cell information associated with the first 5G base station 110-1 or the second 5G base station 110-2 and information indicating whether VoNR is supported by the first 5G base station 110-1 or the second 5G base station 110-2. For example, the UE 105 may collect data on 5G network coverage including details from multiple 5G base stations, such as the first 5G base station 110-1 and second 5G base station 110-2. The UE 105 may receive, from the first 5G base station 110-1 (e.g., that does not support VONR), cell information identifying signal strength, congestion, and/or the like of an access network provided by the first 5G base station 110-1. The UE 105 may receive, from the second 5G base station 110-2 (e.g., that supports VONR), cell information identifying signal strength, congestion, and/or the like of an access network provided by the second 5G base station 110-2. The UE 105 may also receive updates related to network conditions, such as signal strength and congestion, from the 5G base stations 110 to manage ongoing calls efficiently, which allows the UE 105 to adapt to changing network conditions and maintain call quality.

In some implementations, the UE 105 may receive, from the first 5G base station 110-1, information indicating whether VoNR is supported by the first 5G base station 110-1. For example, if the cell information associated with the first 5G base station 110-1 does not include a VoNR emergency bit, the UE 105 may determine that the first 5G base station 110-1 fails to support VoNR calls. Furthermore, if the cell information associated with the second 5G base station 110-2 includes the VoNR emergency bit, the UE 105 may determine that the second 5G base station 110-2 supports VONR calls.

As further shown in FIG. 1A, and by reference number 135, the UE 105 may receive cell information associated with the 4G base station 110. For example, the UE 105 may collect, from the 4G base station 110, cell information identifying signal strength, congestion, LTE network services as a fallback option for voice call continuity, and/or the like of an access network provided by the 4G base station 110. In some implementations, the UE 105 may switch between multiple 4G base stations 110 based on predefined criteria, such as signal strength or connection stability, to maintain call stability and minimize interruptions during voice communication.

As shown in FIG. 1B, and by reference number 140, the UE 105 may temporarily store information associated with the VoWiFi call, the cell information associated with the 4G base station 110, the cell information associated with the first 5G base station 110-1, the cell information associated with the second 5G base station 110-2, and the information indicating whether VoNR is supported by the first 5G base station 110-1 or the second 5G base station 110-2. For example, the UE 105 may temporarily store, in a data structure (e.g., a database, a list, a table, and/or the like), either locally or on a connected cloud service, information associated with the VoWiFi call (e.g., a service set identifier (SSID), a media access control (MAC) address, and/or the like of the access point 115), the cell information (e.g., an evolved cell global identifier (ECGI) of the 4G base station 110) associated with the 4G base station 110, the cell information (e.g., a temporary mobile subscriber identity (TMSI)) associated with the first 5G base station 110-1, the cell information (e.g., a TMSI) associated with the second 5G base station 110-2, and the information indicating whether VoNR is supported by the first 5G base station 110-1 or the second 5G base station 110-2. For example, as shown in the data structure of FIG. 1B, VoNR may be disabled for the first 5G base station 110-1, and VoNR may be enabled for the second 5G base station 110-2. The data structure may also indicate that 5G SA is disabled for the first 5G base station 110-1 and is enabled for the second 5G base station 110-2.

The UE 105 may utilize the data structure to determine whether to handover of the VoWiFi call to the 4G base station or one of the 5G base stations 110 (e.g., if the VoWiFi call experiences degradation). Additionally, or alternatively, the UE 105 may utilize the data structure and predictive analytics to ascertain a most stable 4G or 5G base station 110 to transition to if needed. Additionally, or alternatively, the UE 105 may actively monitor and update the data structure to reflect real-time changes in capabilities of the 4G and 5G base stations 110 based on network notifications, periodically pushed network configuration updates, dynamic signal strength and quality measurements, and/or the like.

In some implementations, the UE 105 may employ fail-safe mechanisms in case the data structure becomes corrupted or outdated, such as defaulting to LTE handover or prompting the user to remain on VoWiFi call until the data structure can be validated. In scenarios where the UE 105 is presented with base stations 110 of equally suitable signal strength but different VoNR capabilities, the UE 105 may utilize additional criteria such as historical reliability, call quality metrics, or user preferences to decide to which base station 110 to hand over.

In some implementations, the UE 105 may utilize the data structure to suggest that a user of the UE 105 move to a location with better VoNR support if the current environment fails to support VONR. This user-guidance may aid in maintaining call quality and may emphasize uninterrupted service for the UE 105. In some implementations, the UE 105 may be configured to alert a network provider when encountering areas with deficient VoNR support, allowing the network provider to focus on infrastructure improvements based on collective user data. By providing feedback to the network provider, the UE 105 may act as a diagnostic tool, contributing to improvement of the network infrastructure for all users.

As shown in FIG. 1C, and by reference number 145, the UE 105 may handover the VoWiFi call to the 4G base station 110 based on the information indicating that VoNR is not supported by the first 5G base station 110-1. For example, the UE 105 may determine that the VoWiFi call should be handed over to a cellular network based on an indication of congestion associated with the access point 115, based on assessing quality metrics associated with the VoWiFi call, based on monitoring for threshold conditions defined for handing over the VoWiFi call, and/or the like. When the UE 105 determines that the VoWiFi call is to be handed over, the UE 105 may determine whether to hand over the VoWiFi call to the 4G based station 110 or to the first 5G base station 110-1. However, since the information indicates that VoNR is not supported by the first 5G base station 110-1, the UE 10 may determine that the VoWiFi call is to be handed over to the 4G base station 110 (e.g., the EPS fallback). In some implementations, the UE 105 may consider a battery level or a power consumption profile as an additional factor when deciding to hand over a VoWiFi call, thereby extending device usability during calls. This battery-aware feature may enable the UE 105 to manage calls without compromising operational longevity.

Upon determining that VoNR is not supported by the first 5G base station 110-1 in communication with the UE 105, the UE 105 may initiate a handover of the VoWiFi call to the 4G base station 110, which supports LTE access and the EPS fallback. Additionally, or alternatively, handing over the VoWiFi call may include transferring the call to an alternative communication protocol that is supported by the 4G base station 110, such as voice-over-LTE (VOLTE). This may maintain call continuity within a coverage area of the 4G base station 110, thereby avoiding unnecessary handovers. In some implementations, handing over the VoWiFi call may include receiving assistance from the core network 120 in the form of commands or signals to facilitate the handover process. This would ensure a smoother transition and minimize any potential call disruption that the UE 105 might experience. Additionally, or alternatively, handing over the VoWiFi call may include employing specific, such as signal quality metrics or predefined thresholds, to make a decision on whether to proceed with the handover to the 4G base station 110.

Additionally, or alternatively, upon determining that VoNR is not supported by the first 5G base station 110-1, the UE 105 may delay the handover to the 4G base station 110 to allow for a potential short-term improvement in VoWiFi call conditions. This could potentially improve user experience if the call conditions are acceptable and the VoWiFi connection remains stable. Additionally, or alternatively, the UE 105 may periodically update a decision on whether to utilize a VoWiFi call or to maintain the voice call via the 4G base station 110 based on dynamic network conditions or updated network information.

The handover of the VoWiFi call to the 4G base station 110 may provide a seamless transition without user intervention or perceptible call quality issues. The network-aware behavior of the UE 105 may enhance the user experience by automatically adapting to network capabilities and conditions. The handover to the 4G base station 110 avoids potential audio gaps or a call drop that could result from multiple handovers or inadequate 5G network support for voice calls.

As shown in FIG. 1D, and by reference number 150, the UE 105 may handover the VoWiFi call to the second 5G base station 110-2 based on the information indicating that VONR is supported by the second 5G base station 110-2. For example, the UE 105 may determine that the VoWiFi call should be handed over to a cellular network based on an indication of congestion associated with the access point 115, based on assessing quality metrics associated with the VoWiFi call, based on monitoring for threshold conditions defined for handing over the VoWiFi call, and/or the like. When the UE 105 determines that the VoWiFi call is to be handed over, the UE 105 may determine whether to hand over the VoWiFi call to the 4G based station 110 or to the second 5G base station 110-2. However, since the information indicates that VoNR is supported by the second 5G base station 110-2, the UE 10 may determine that the VoWiFi call is to be handed over to the second 5G base station 110-2 as a VoNR call.

The UE 105, which is configured to initiate and maintain VoWiFi calls, may assess the availability and support of VoNR by nearby 5G base stations 110. When the UE 105 receives confirmation that the second 5G base station 110-2 is capable of supporting VoNR, the UE 105 may initiate a handover procedure for handing over the VoWiFi call to the second 5G base station 110-2 as a VoNR call. Additionally, or alternatively, the handover of the VoWiFi call to the second 5G base station 110-2 may be triggered not only by VoNR support but also by a combination of parameters, such as signal quality, network load, and/or the like. Such an approach may consider a range of factors to optimize the user experience during handover. In some implementations, the actual handover process from VoWiFi to VoNR performed by the UE 105 mayo ensure continued communication with minimal disruption to the user. Additionally, or alternatively, the UE 105 may choose to maintain the VoWiFi call without handover if the UE 105 determines overall superior performance metrics for the VoWiFi call compared to available cellular options, including but not limited to VoNR. With such an approach, the UE 105 may ensure that the highest quality communication is maintained.

The handover of the VoWiFi call to the second 5G base station 110-2 may provide an optimized and seamless transition between different access technologies, and may ensure high-quality voice communication and improved user experience. With the ability to dynamically select between VoWiFi and cellular networks based on the presence of VoNR support, the UE 105 may optimize network usage and minimize call disruptions due to changes in network conditions or coverage.

FIG. 1E is an example call flow diagram associated with optimizing a VoWiFi call for a VoNR device. As shown at step 1 of FIG. 1E, the UE 105 may be conducting an ongoing VoWiFi call via the access point 115. For example, the UE 105 may engage in a communication session over Wi-Fi connectivity with the assistance of the access point 115, providing a VoWiFi call experience. In some implementations, the UE 105 may determine to initiate a handover process targeting a base station 110 that supports a different radio access technology in the event that the VoWiFi call experiences degradation. As shown at step 2, the UE 105 may provide a VoWiFi to NR handover (HO) request to the first 5G base station 110-1 (e.g., that does not support VONR). Here, the UE 105 initiates a handover process aiming to transition the existing VoWiFi call to a 5G base station 110 associated with the NR access. This process reflects an attempt of the UE 105 to migrate the call from Wi-Fi to a cellular network that operates under the NR protocol.

As shown at step 3, the first 5G base station 110-1 may provide a voice call HO to NR request to the core network 120. The first 5G base station 110-1 may utilize the voice call HO to NR request to relay the VoWiFi to NR HO request to one or more network devices of the core network 120, where further processing to facilitate the handover is conducted. The voice call HO to NR request may include information requesting the feasibility of the handover to the first 5G base station 110-1. When 5G base stations 110 are configured, an access and mobility management function (AMF) and/or a session management function (SMF) of the core network 120 determines that a 5G base station 110 does not support VoNR based on requesting support for voice and the request being rejected, and determines that a 5G base station 110 supports VoNR based on requesting support for voice and the request being accepted.

As shown at step 4, a network device (e.g., the AMF or the SMF) of the core network 120 may provide, to the first 5G base station 110-1, a message indicating that a voice call HO request fallback (FB) with EPS FB is required for the voice call. For example, the network device of the core network 120 may determine that VoNR support is unavailable at the first 5G base station 110-1 and may direct a fallback to EPS. Additionally, or alternatively, in cases where the EPS fallback is invoked, the UE 105 may execute a preemptive search for a 4G base station 110 with optimal performance metrics before receiving a directive to fall back to ensure a swift and efficient handover. This proactive approach can result in a smoother call transition by immediately directing the UE 105 toward the most favorable LTE network available.

As shown at step 5 of FIG. 1E, the UE 105 may receive, from the first 5G base station 110-1, a message indicating that the VoWiFi HO request is rejected and that the EPS FB is required. Consequently, the UE 105 may be directed to revert to an EPS-supported network (e.g., the 4G base station 110) for call continuance. Additionally, or alternatively, the UE 105 may store the outcome of the handover request for future reference, creating a log that can be used to inform subsequent handover decisions or to update network preferences stored in the UE 105.

As shown at step 6, the UE 105 may receive, from the first 5G base station 110-1, a message triggering the EPS FB or an intra-radio access technology (IRAT) HO. For example, the message may trigger the UE 105 begin the EPS FB process with the 4G base station 110. Additionally, or alternatively, if the UE 110 identifies a preferred 4G base station 110 based on previous successful handovers, the UE 105 may directly request a VoWiFi to LTE handover from the core network 120 without awaiting the fallback message. This direct approach can potentially bypass lengthy processing times, expediting the handover procedure.

As shown at step 7, the UE 105 may receive, from the 4G base station 110, a message indicating that the UE 105 is to fall back to the 4G base station 110 (e.g., LTE) for the VoWiFi call. This transition enables the VoWiFi call to proceed on the LTE network. As shown at step 8, the UE 105 may provide a VoWiFi to LTE HO request to the 4G base station 110. This request is intended to facilitate the handover to LTE network infrastructure. Additionally, or alternatively, during the EPS fallback, the UE 105 may perform a dynamic evaluation of the network conditions to determine whether to proceed with the handover or to maintain the VoWiFi call until conditions improve. This real-time assessment might warrant delaying the handover if the Wi-Fi network offers a superior experience compared to immediate LTE connectivity.

As shown at steps 9 and 10, the UE 105 may receive, from the 4G base station 110, a message permitting a voice call on LTE, and may conduct a voice call on LTE via the 4G base station 110. These steps result in a successful voice call routing through the LTE network. Additionally, or alternatively, the UE 105 may communicate with multiple base stations 110 simultaneously to preemptively establish the quickest handover path, thus minimizing call disruption during the transition between different radio access technologies. This may anticipate potential handover scenarios and may prepare the UE 105 for an immediate switch, further enhancing call continuity.

FIG. 1F is another example call flow diagram associated with optimizing a VoWiFi call for a VoNR device. As shown at step 1 of FIG. 1E, the UE 105 may be conducting an ongoing VoWiFi call via the access point 115. For example, the UE 105 may engage in a communication session over Wi-Fi connectivity with the assistance of the access point 115, providing a VoWiFi call experience. In some implementations, the UE 105 may determine to initiate a handover process targeting a base station 110 that supports a different radio access technology in the event that the VoWiFi call experiences degradation. As shown at step 2, the UE 105 may provide a VoWiFi to NR HO request to the second 5G base station 110-2 (e.g., that supports VONR). Here, the UE 105 initiates a handover process aiming to transition the existing VoWiFi call to a 5G base station 110 associated with the NR access. This process reflects an attempt of the UE 105 to migrate the call from Wi-Fi to a cellular network that operates under the NR protocol.

As shown at step 3, the second 5G base station 110-2 may provide a voice call HO to NR request to the core network 120. The second 5G base station 110-2 may utilize the voice call HO to NR request to relay the VoWiFi to NR HO request to one or more network devices of the core network 120, where further processing to facilitate the handover is conducted. The voice call HO to NR request may include information requesting the feasibility of the handover to the second 5G base station 110-2. When the second 5G base station 110-2 is configured, the AMF and/or the SMF of the core network 120 determine that the second 5G base station 110-2 supports VONR based on requesting support for voice and the request being accepted.

As shown at step 4, a network device (e.g., the AMF or the SMF) of the core network 120 may provide, to the second 5G base station 110-2, a message indicating that a voice call HO to NR request is approved. For example, the network device of the core network 120 may determine that VoNR support is available at the second 5G base station 110-2 and may direct a VoNR via the second 5G base stations 110-2. Additionally, or alternatively, the UE 105 may execute a preemptive search for a 5G base station 110 with optimal performance metrics before receiving a directive for VoNR to ensure a swift and efficient handover. This proactive approach can result in a smoother call transition by immediately directing the UE 105 toward the most favorable NR network available.

As shown at steps 5 and 6, the UE 105 may receive, from the second 5G base station 110-2, a message permitting a voice call on NR, and may conduct a voice call on NR via the second 5G base station 110-2. These steps result in a successful voice call routing through the NR network provided by the second 5G base station 110-2. Additionally, or alternatively, the UE 105 may communicate with multiple 5G base stations 110 simultaneously to preemptively establish the quickest handover path, thus minimizing call disruption during the transition between different radio access technologies. This may anticipate potential handover scenarios and may prepare the UE 105 for an immediate switch, further enhancing call continuity.

In this way, the UE 105 optimizes a VoWiFi call for a VoNR device. For example, the UE may optimize voice call transitions between VoWiFi and 5G SA networks. The UE 105 may initiate a VoWiFi call and may receive cell information from both a first base station with NR access and a second base station providing LTE access, including data indicating whether VoNR is supported by the first base station. The UE 105 may temporarily store relevant information associated with the call and the cell information, and may selectively hand over the call to the appropriate base station based on the VoNR support status. Thus, the UE 105 may conserve computing resources, networking resources, and/or other resources that would have otherwise been consumed by performing multiple handovers for a VoWiFi call to a 5G access device and then to a 4G access device (e.g., the EPS FB), causing a poor user experience for a user of the UE 105 due to the multiple handovers for a VoWiFi call, unnecessarily utilizing resources of a 5G access device that does not support VONR, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

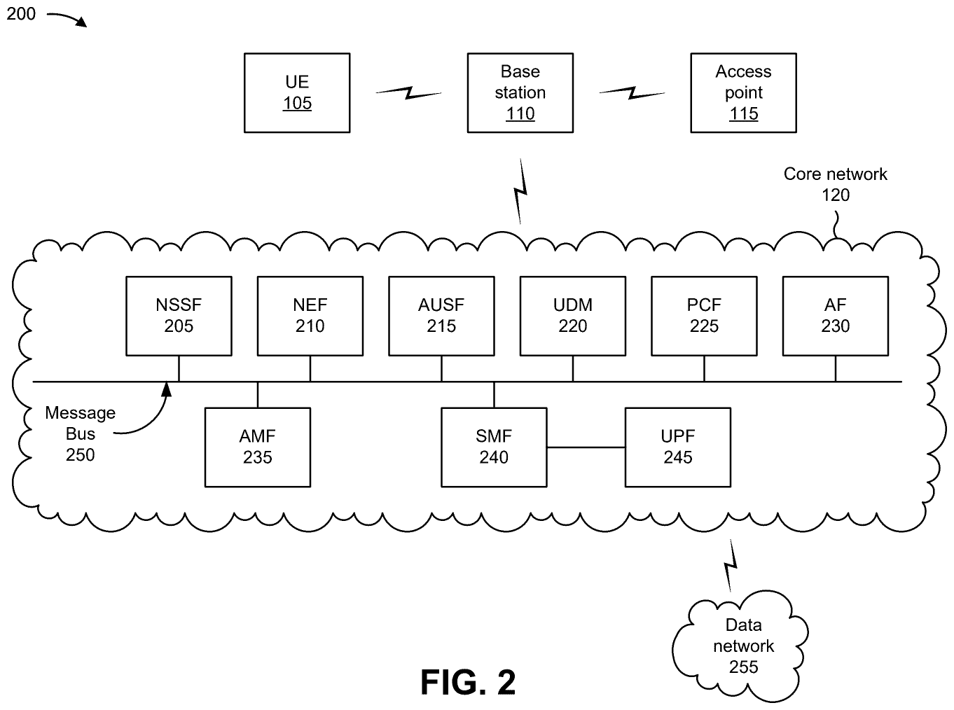

FIG. 2 is a diagram of an example environment 200 in which systems and/or methods described herein may be implemented. As shown in FIG. 2, the example environment 200 may include the UE 105, a base station 110, the access point 115, the core network 120, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 120. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

The access point 115 includes one or more devices capable of receiving, generating, storing, processing, and/or providing information, such as information described herein. For example, the access point 115 may include a device that sends and receives data wirelessly over radio frequencies, using particular frequency bands (e.g., 2.4 Gigahertz (GHz) or 5 GHz bands). Client devices, such as the UE 105, may connect to the access point 115 using a wireless signal, enabling the client devices to join a wireless local area network (LAN) created by the access point 115. An Ethernet cable may physically connect the access point 115 to a router or a switch in a wired LAN, which provides the access point 115 with access to the Internet and other networks.

In some implementations, the core network 120 may include an example functional architecture in which systems and/or methods described herein may be implemented. For example, the core network 120 may include an example architecture of a fifth generation (5G) next generation (NG) core network included in a 5G wireless telecommunications system. While the example architecture of the core network 120 shown in FIG. 2 may be an example of a service-based architecture, in some implementations, the core network 120 may be implemented as a reference-point architecture and/or a 4G core network, among other examples.

As shown in FIG. 2, the core network 120 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 120.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane quality of service (QOS), among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

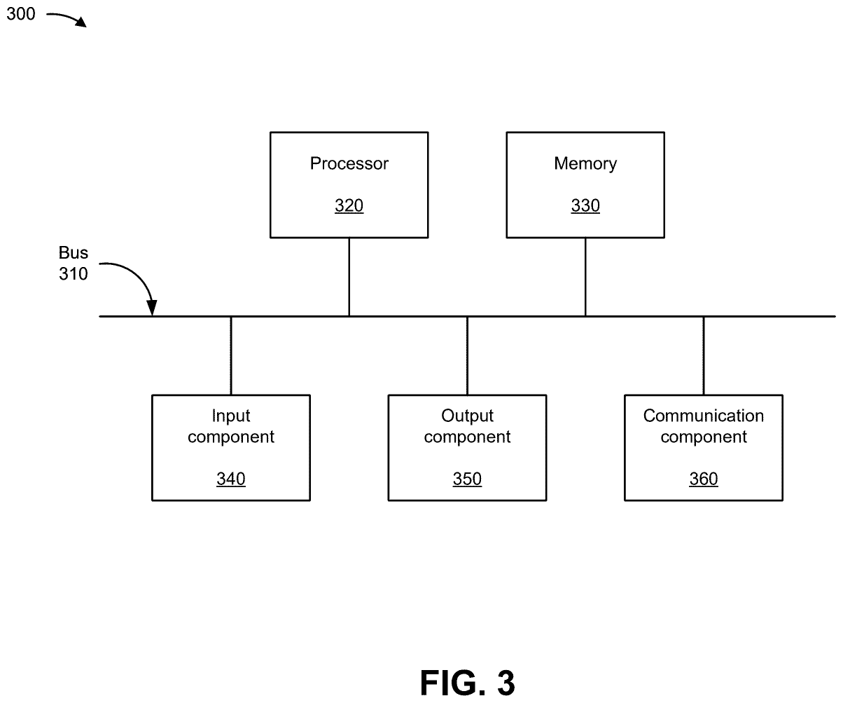

FIG. 3 is a diagram of example components of a device 300, which may correspond to the UE 105, the base station 110, the access point 115, the NSSF 205, the NEF 210, the AUSF 215, the UDM 220, the PCF 225, the AF 230, the AMF 235, the SMF 240, and/or the UPF 245. In some implementations, the UE 105, the base station 110, the access point 115, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

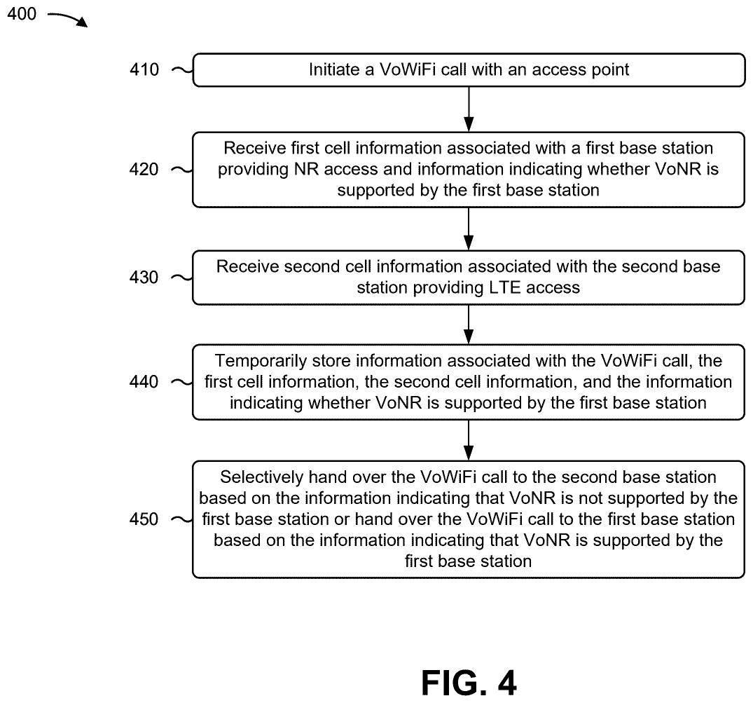

FIG. 4 is a flowchart of an example process 400 for optimizing a VoWiFi call for a VoNR device. In some implementations, one or more process blocks of FIG. 4 may be performed by a device (e.g., the UE 105). In some implementations, one or more process blocks of FIG. 4 may be performed by another device or a group of devices separate from or including the device, such as a network device of the core network 120. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include initiating a VoWiFi call with an access point (block 410). For example, the device may initiate a VoWiFi call with an access point, as described above.

As further shown in FIG. 4, process 400 may include receiving first cell information associated with a first base station providing NR access and information indicating whether VoNR is supported by the first base station (block 420). For example, the device may receive first cell information associated with a first base station providing NR access and information indicating whether VoNR is supported by the first base station, as described above. In some implementations, the information indicating whether VoNR is supported by the first base station is based on an emergency information bit indicating that VoNR is supported by the first base station.

As further shown in FIG. 4, process 400 may include receiving second cell information associated with a second base station providing LTE access (block 430). For example, the device may receive second cell information associated with a second base station providing LTE access, as described above.

As further shown in FIG. 4, process 400 may include temporarily storing information associated with the VoWiFi call, the first cell information, the second cell information, and the information indicating whether VoNR is supported by the first base station (block 440). For example, the device may temporarily store information associated with the VoWiFi call, the first cell information, the second cell information, and the information indicating whether VONR is supported by the first base station, as described above.

As further shown in FIG. 4, process 400 may include selectively handing over the VoWiFi call to the second base station based on the information indicating that VoNR is not supported by the first base station or handing over the VoWiFi call to the first base station based on the information indicating that VoNR is supported by the first base station (block 450). For example, the device may selectively hand over the VoWiFi call to the second base station based on the information indicating that VoNR is not supported by the first base station or hand over the VoWiFi call to the first base station based on the information indicating that VONR is supported by the first base station, as described above.

In some implementations, process 400 includes receiving an indication of congestion associated with the access point, and determining to hand over the VoWiFi call based on the indication of congestion with the access point.

In some implementations, process 400 includes initiating another VoWiFi call with the access point; providing a VoWiFi to NR handover request to the first base station to cause the first base station to receive, from a core network device, a message indicating that a voice call handover request fallback with EPS fallback is required for the voice call; receiving, from the first base station, a message indicating that the VoWiFi to NR handover request is rejected and that the EPS fallback is required; receiving, from the second base station, a message indicating that the device is to fall back to the second base station for the other VoWiFi call; and handing over the other VoWiFi call to the second base station based on the message indicating that the device is to fall back to the second base station for the other VoWiFi call. In some implementations, handing over the other VoWiFi call to the second base station includes providing a VoWiFi to LTE handover request to the second base station, and conducting a voice call on LTE via the second base station based on the VoWiFi to LTE handover request. In some implementations, process 400 includes receiving an indication of congestion associated with the access point, and determining to hand over the other VoWiFi call based on the indication of congestion with the access point.

In some implementations, process 400 includes initiating another VoWiFi call with the access point; providing a VoWiFi to NR handover request to the first base station to cause the first base station to receive, from a core network device, a message indicating that a voice call handover to NR is approved; receiving, from the first base station, a message indicating that the VoWiFi to NR handover request is approved; and handing over the other VoWiFi call to the first base station based on the message indicating that the VoWiFi to NR handover request is approved. In some implementations, process 400 includes receiving an indication of congestion associated with the access point, and determining to hand over the other VoWiFi call based on the indication of congestion with the access point.

In some implementations, process 400 includes assessing quality metrics associated with the VoWiFi call, and determining to hand over the other VoWiFi call based on the quality metrics. In some implementations, process 400 includes preventing handover of the VoWiFi call to the first base station based on a core network device indicating that VoNR is not supported by the first base station.

In some implementations, process 400 includes allowing handover of the VoWiFi call to the first base station based on a core network device indicating that VoNR is supported by the first base station. In some implementations, process 400 includes initiating another VoWiFi call with the access point, and deleting, based on initiating the other VoWiFi call, the information associated with the VoWiFi call, the first cell information, the second cell information, and the information indicating whether VoNR is supported by the first base station. In some implementations, process 400 includes monitoring for threshold conditions defined for handing over the VoWiFi call, and determining to hand over the VoWiFi call based on monitoring for the threshold conditions.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
initiating, by a device, a voice-over-Wi-Fi (VoWiFi) call with an access point;
receiving, by the device, first cell information associated with a first base station providing New Radio (NR) access and information indicating whether voice-over-NR (VONR) is supported by the first base station;
receiving, by the device, second cell information associated with a second base station providing Long Term Evolution (LTE) access;
storing, temporarily by the device, information associated with the VoWiFi call, the first cell information, the second cell information, and the information indicating whether VoNR is supported by the first base station; and
selectively:
handing over the VoWiFi call to the second base station based on the information indicating that VoNR is not supported by the first base station; or
handing over the VoWiFi call to the first base station based on the information indicating that VoNR is supported by the first base station.

2. The method of claim 1, further comprising:
receiving an indication of congestion associated with the access point; and
determining to hand over the VoWiFi call based on the indication of congestion with the access point.

3. The method of claim 1, further comprising:
initiating another VoWiFi call with the access point;
providing a VoWiFi to NR handover request to the first base station to cause the first base station to receive, from a core network device, a message indicating that a voice call handover request fallback with evolved packet system (EPS) fallback is required for the voice call;
receiving, from the first base station, a message indicating that the VoWiFi to NR handover request is rejected and that the EPS fallback is required;
receiving, from the second base station, a message indicating that the device is to fall back to the second base station for the other VoWiFi call; and
handing over the other VoWiFi call to the second base station based on the message indicating that the device is to fall back to the second base station for the other VoWiFi call.

4. The method of claim 3, wherein handing over the other VoWiFi call to the second base station comprises:
providing a VoWiFi to LTE handover request to the second base station; and
conducting a voice call on LTE via the second base station based on the VoWiFi to LTE handover request.

5. The method of claim 3, further comprising:
receiving an indication of congestion associated with the access point; and
determining to hand over the other VoWiFi call based on the indication of congestion with the access point.

6. The method of claim 1, further comprising:
initiating another VoWiFi call with the access point;
providing a VoWiFi to NR handover request to the first base station to cause the first base station to receive, from a core network device, a message indicating that a voice call handover to NR is approved;
receiving, from the first base station, a message indicating that the VoWiFi to NR handover request is approved; and
handing over the other VoWiFi call to the first base station based on the message indicating that the VoWiFi to NR handover request is approved.

7. The method of claim 6, further comprising:
receiving an indication of congestion associated with the access point; and
determining to hand over the other VoWiFi call based on the indication of congestion with the access point.

8. A device, comprising:
one or more processors configured to:
initiate a voice-over-Wi-Fi (VoWiFi) call with an access point;
receive first cell information associated with a first base station providing New Radio (NR) access and information indicating whether voice-over-NR (VoNR) is supported by the first base station;
receive second cell information associated with a second base station providing Long Term Evolution (LTE) access;
temporarily store information associated with the VoWiFi call, the first cell information, the second cell information, and the information indicating whether VoNR is supported by the first base station;
receive an indication of congestion associated with the access point;
determine to hand over the VoWiFi call based on the indication of congestion with the access point; and
selectively:
hand over the VoWiFi call to the second base station based on the information indicating that VoNR is not supported by the first base station; or
hand over the VoWiFi call to the first base station based on the information indicating that VoNR is supported by the first base station.

9. The device of claim 8, wherein the information indicating whether VoNR is supported by the first base station is based on an emergency information bit indicating that VoNR is supported by the first base station.

10. The device of claim 8, wherein the one or more processors are further configured to:
assess quality metrics associated with the VoWiFi call; and
determine to hand over the other VoWiFi call based on the quality metrics.

11. The device of claim 8, wherein the one or more processors are further configured to:
prevent handover of the VoWiFi call to the first base station based on a core network device indicating that VoNR is not supported by the first base station.

12. The device of claim 8, wherein the one or more processors are further configured to:
allow handover of the VoWiFi call to the first base station based on a core network device indicating that VoNR is supported by the first base station.

13. The device of claim 8, wherein the one or more processors are further configured to:
initiate another VoWiFi call with the access point; and
delete, based on initiating the other VoWiFi call, the information associated with the VoWiFi call, the first cell information, the second cell information, and the information indicating whether VoNR is supported by the first base station.

14. The device of claim 8, wherein the one or more processors are further configured to:
monitor for threshold conditions defined for handing over the VoWiFi call; and
determine to hand over the VoWiFi call based on monitoring for the threshold conditions.

15. A non-transitory computer-readable medium storing a set of instructions, the set of instructions comprising:
one or more instructions that, when executed by one or more processors of a device, cause the device to:
initiate a voice-over-Wi-Fi (VoWiFi) call with an access point;
receive first cell information associated with a first base station providing New Radio (NR) access and information indicating whether voice-over-NR (VONR) is supported by the first base station;
receive second cell information associated with a second base station providing Long Term Evolution (LTE) access;
temporarily store information associated with the VoWiFi call, the first cell information, the second cell information, and the information indicating whether VoNR is supported by the first base station;
monitor for threshold conditions defined for handing over the VoWiFi call;
determine to hand over the VoWiFi call based on monitoring for the threshold conditions; and
selectively:
hand over the VoWiFi call to the second base station based on the information indicating that VoNR is not supported by the first base station; or
hand over the VoWiFi call to the first base station based on the information indicating that VoNR is supported by the first base station.

16. The non-transitory computer-readable medium of claim 15, wherein the one or more instructions further cause the device to:
initiate another VoWiFi call with the access point;
provide a VoWiFi to NR handover request to the first base station to cause the first base station to receive, from a core network device, a message indicating that a voice call handover request fallback with evolved packet system (EPS) fallback is required for the voice call;
receive, from the first base station, a message indicating that the VoWiFi to NR handover request is rejected and that the EPS fallback is required;
receive, from the second base station, a message indicating that the device is to fall back to the second base station for the other VoWiFi call; and
hand over the other VoWiFi call to the second base station based on the message indicating that the device is to fall back to the second base station for the other VoWiFi call.

17. The non-transitory computer-readable medium of claim 16, wherein the one or more instructions, that cause the device to hand over the other VoWiFi call to the second base station, cause the device to:
provide a VoWiFi to LTE handover request to the second base station; and
conduct a voice call on LTE via the second base station based on the VoWiFi to LTE handover request.

18. The non-transitory computer-readable medium of claim 16, wherein the one or more instructions further cause the device to:
receive an indication of congestion associated with the access point; and
determine to hand over the other VoWiFi call based on the indication of congestion with the access point.

19. The non-transitory computer-readable medium of claim 15, wherein the one or more instructions further cause the device to:
initiate another VoWiFi call with the access point;
provide a VoWiFi to NR handover request to the first base station to cause the first base station to receive, from a core network device, a message indicating that a voice call handover to NR is approved;
receive, from the first base station, a message indicating that the VoWiFi to NR handover request is approved; and
hand over the other VoWiFi call to the first base station based on the message indicating that the VoWiFi to NR handover request is approved.

20. The non-transitory computer-readable medium of claim 19, wherein the one or more instructions further cause the device to:
receive an indication of congestion associated with the access point; and
determine to hand over the other VoWiFi call based on the indication of congestion with the access point.
